(19) United States
(12) Patent Application Publication
(10) Pub. No.: US 2019/0354331 A1
(43) Pub. Date: Nov. 21, 2019

(54) MIRROR-BASED INFORMATION INTERFACE AND EXCHANGE

(71) Applicants: Glenn Neugarten, Los Angeles, CA (US); Paige Neugarten, Los Angeles, CA (US)

(72) Inventors: Glenn Neugarten, Los Angeles, CA (US); Paige Neugarten, Los Angeles, CA (US)

(21) Appl. No.: 16/415,630

(22) Filed: May 17, 2019

Related U.S. Application Data
(60) Provisional application No. 62/673,396, filed on May 18, 2018.

(51) Int. Cl. G06F 3/147; G06Q 50/16; G06Q 30/06; G06F 3/0488; G06F 3/0482; G06F 3/0484

(52) U.S. Cl. CPC G06F 3/147; G06Q 50/163; G06Q 30/0641; G06F 3/0202; G06F 3/0482; G06F 3/04845; G06F 3/04886

(57) ABSTRACT

A smart mirror for operating a virtual hospitality service. The smart mirror can include at least a controller, a semi-transparent mirror panel, and a display. The controller can be configured for communication with a property management system, such as a property management system of a hospitality provider. The display can be configured to render a user interface for projection through the semi-transparent mirror panel. The user interface can be adapted to present information from the property management system, and receive a user input from an input device for communication with the property management system.

### CROSS-REFERENCE TO RELATED APPLICATIONS

This application claims the benefit of U.S. provisional application No. 62/673,396, filed 18 May 2018, which is hereby incorporated by reference as though fully set forth herein.

### BACKGROUND

### a. Field

The instant disclosure relates to a smart mirror. In one embodiment, the instant disclosure relates to a smart mirror operatively coupled with a property management system.

### b. Background Art

Existing monitors can be configured for display through a two-way mirror. Accordingly, the mirror can function both for providing a reflective surface or for viewing subject matter displayed on the monitor. Such devices can be programed by a user to display items from a personal computer, such as a tablet or other like devices. Often, these devices are configured to display personal files or run applications installed on a personal computer. In some examples, the personal computer can use an operating system such as Microsoft Windows, Apple IOS, Raspberry Pi Raspbian, or the like. The foregoing discussion is intended only to illustrate the present field and should not be taken as a disavowal of claim scope.

### BRIEF SUMMARY

The instant disclosure relates to a smart mirror for use with a property management system. The smart mirror can provide access to concierge or hospitality related services from a multi-purpose user interface within a guest room associated with the property management system. For example, the smart mirror can be integrated with a hospitality provider's (e.g., hotel's) property management system to provide hospitality services entertainment, and other information to a guest of the hospitality provider. Some embodiments can include a smart mirror for operating a virtual hospitality service. The smart mirror can include a controller, a semi-transparent mirror panel, and a display. The controller can be configured for communication with a property management system, such as a property management system of the hospitality provider. The display can be configured to render a user interface for projection through a semi-transparent mirror panel. For instance, the semi-transparent mirror can include a semi-transparent mirror panel, such as a two-way mirror or a one-way mirror. The user interface can be adapted to present information from the property management system. In some embodiments, the user interface can be adapted to receive a user input for communication with the property management system. In further embodiments, the smart mirror can be communicatively coupled to the property management system. Accordingly, the smart mirror can be included in a system, such as the property management system.

In an embodiment, the smart mirror can include a user interface. The user interface can include, but is not limited to, presenting location-specific information, reservation detail, or one or more hospitality service icons arranged on a home screen. For instance, the location-specific information can include, but is not limited to, one or more of weather information, geographic location field, time, a local event list, or the like. In an embodiment, the reservation detail can include a checkout day and a checkout time. The one or more hospitality service icons can be configured for linking to hospitality services and for selecting various hospitality service requests.

Another embodiment can include a method for controlling the smart mirror. The method can include obtaining information from a property management system at a controller. The controller can be communicatively coupled with the smart mirror having the semi-transparent mirror panel. The method can further include presenting information from the property management system on the user interface of the display. For instance, the display can be configured to project the user interface through the semi-transparent mirror panel. In some embodiments, the method can include receiving a user input selected from the display for communication with the property management system.

Accordingly, the smart mirror can provide the function of a traditional mirror as well as include functionality of a multi-purpose user interface for providing access to concierge or hospitality related services. The foregoing and other aspects, features, details, utilities, and advantages of the present disclosure will be apparent from reading the following description and claims, and from reviewing the accompanying drawings.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an exploded view of an example of a smart mirror.

FIG. 2 is a diagram of an example of a system including a smart mirror.

FIG. 3 is a depiction of an example of a user interface of a smart mirror including a home screen presented in the user interface.

FIG. 4 is an illustration of an example of a user interface of a hospitality services menu.

FIG. 5 is an illustration of an example of a room service user interface presented by a smart mirror.

FIG. 6 is an illustration of an example of a map interface presented by a smart mirror.

FIG. 7 is an example of an online shopping user interface presented in the smart mirror.

FIG. 8 is an example of a method of controlling a smart mirror.

### DETAILED DESCRIPTION OF EMBODIMENTS

Several embodiments of a smart mirror for use with a property management system are disclosed herein. The smart mirror can be located within a guest room associated with the property management system. The smart mirror can include a multi-purpose user interface to provide access to concierge or hospitality related services. For example, the smart mirror can be integrated with a hospitality provider's (e.g., hotel's) property management system to provide hospitality services, entertainment, or other information to a guest of the hospitality provider. Details of the various embodiments of the present disclosure are described below with specific reference to the figures.

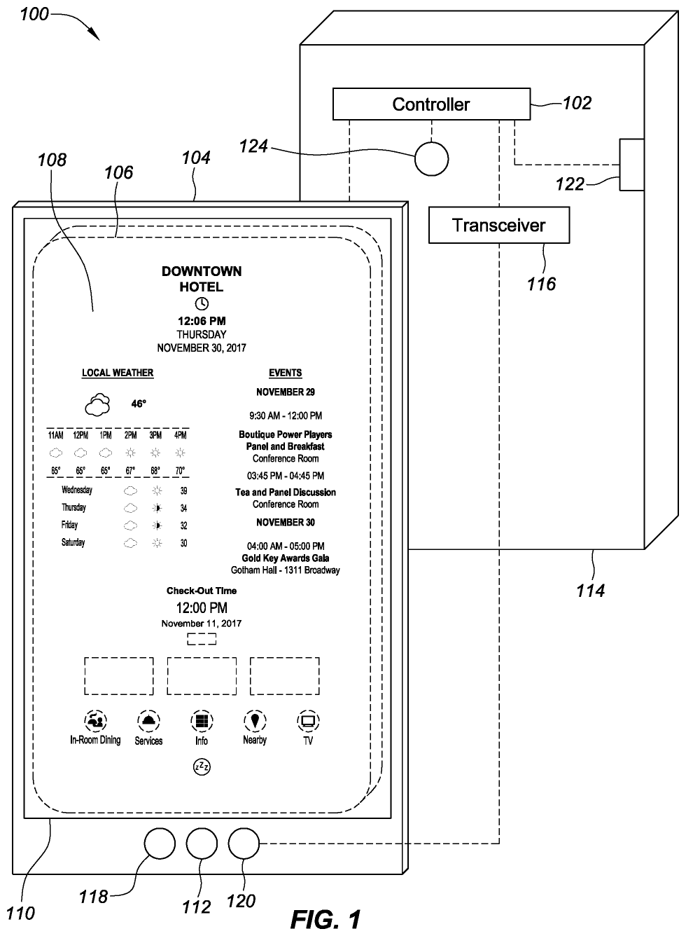

FIG. 1 is an exploded view of an example of a smart mirror 100. The smart mirror 100 can include a controller 102, a semi-transparent mirror panel 104, a display 106, and a user interface 108. The controller 102 can be communicatively coupled with the display 106 to present the user interface 108. The user interface 108 can be projected from the display 106 through the semi-transparent mirror panel 104 for viewing by a user. As described herein, a user can include a guest of the hospitality provider and the terms user and guest can be used interchangeably. In the embodiment of FIG. 1, the controller 102 can be coupled to a structural cabinet 114. The structural cabinet 114 can be a sheet metal enclosure configured for mounting various components of the smart mirror (e.g., controller 102) or managing wire routing. The semi-transparent mirror panel 104 can be coupled to the structural cabinet 114. In some embodiments, a decorative cabinet can be included around the structural cabinet 114 or a decorative frame can be coupled to the semi-transparent mirror panel 104 for improved cosmetics. Various shapes and sizes of the semi-transparent mirror panel 104, display 106, user interface 108, structural cabinet, decorative cabinet, decorative frame, or the like are contemplated within the scope of this disclosure. In some embodiments, the various sizes and shapes of the semi-transparent mirror panel 104, display 106, user interface 108, structural cabinet, decorative cabinet, or decorative frame can be interchangeable for use with one another.

The semi-transparent mirror panel can include a one-way or a two-way mirror. For instance, the semi-transparent mirror panel 104 can be reflective on a first side and can be partially transparent for projecting an image (e.g., user interface 108) from a second side. In an embodiment, the semi-transparent mirror panel 104 can include a sheet of glass or polymer (e.g., transparent or partially transparent polymer) with a reflective layer disposed on a first side of the panel, a second side of the panel, or at a location therebetween. In various embodiments, the reflective layer can include, but is not limited to, a half-silvered mirror layer, a perforated metallic layer, sputtered metallic layer, a dichroic optical coating, or the like.

In various embodiments, the display 106 can include, but is not limited to, a liquid crystal display (LCD), light emitting diode (LED), organic LED, plasma, cathode ray tube, or other type of electronic display. The display 106 can be located on or adjacent to one of the sides of the semi-transparent mirror surface 104. In some embodiments, a light barrier (e.g., gasket) can be located around the periphery of the display 106. In an embodiment, the light barrier can reduce light transmission from the display 106 in directions other than through the semi-transparent mirror panel 104. In another embodiment, the light barrier can inhibit light from entering between the display 106 and the semi-transparent mirror panel 104. Accordingly, the image from the display 106 (e.g., user interface 108) can be projected through the semi-transparent mirror panel 104 while the smart mirror 100 is reflective on the first side. In a further embodiment, the display 106 can be a touch-screen display configured to receive a user input through the semi-transparent mirror panel 104.

The controller 102 can include at least a logic device, a memory component, or both. For instance, the controller can be an integrated circuit. The logic device can include, but is not limited to, a processor, central processing unit (CPU), graphics processing unit (GPU), microprocessor, application specific integrated circuit (ASIC), a field programmable gate array (FPGA), complementary metal-oxide-semiconductor (CMOS), or the like. In some embodiments, the memory can include, but is not limited to, random-access memory (RAM), read-only memory (ROM), programmable read-only memory (PROM), erasable programmable read-only memory (EPROM), and electrically erasable programmable read-only memory (EEPROM), dynamic random-access memory (DRAM), static random-access memory (SRAM), Flash memory, or the like. The controller 102 can be communicatively coupled to the display 106, an input device, and a transceiver 116. The controller 102 can execute instructions to present the user inter face 108 on the display 106. In some embodiments, the controller 102 can include a system on chip (SOC). In another embodiment, the controller 102 can include hardware-backed cryptographic services. For instance, the hardware-backed cryptographic services can be implemented into the SOC to provide increased security to the smart mirror 100.

In some embodiments, the logic device of the controller 102 can include one or more sets of processing instructions stored thereon. For instance, the processing instructions can include one or more operating systems including, but not limited to, Android, Microsoft Windows, Apple MS, Raspberry Pi Raspbian, or the like.

The input device can be configured to communicate a command from the user to the controller 102. In some embodiments, the input device can be configured to recognize a user input corresponding to an element of the user interface 108, such as a soft key, icon, or the like. In various embodiments, the input device can include hardware or software implemented buttons. For example, the input device can include a touch-panel overlay 110. The buttons (e.g., icons) can be presented in the user interface 108 for selection by the user on the touch-panel overlay 110. The touch-panel overlay 110 can detect the user input and communicate a signal corresponding to the user input to the controller 102. In various embodiments, the touch-panel overlay 110 can be a capacitive, resistive, optical, acoustic, radio-frequency, or other type of touch-panel overlay. In an embodiment, the touch-panel overlay 110 can be a multi-touch overlay.

In a further embodiment, the input device can include an electromechanical switch 112, such as a push button switch or the like. In the embodiment of FIG. 1, the smart mirror 100 can include multiple input devices, such as the touch-panel overlay 110 and one or more electromechanical switches 112. One or more electromechanical switches 112 can be positioned on, though, or adjacent to the semi-transparent mirror panel 104. For instance, in some embodiments, the smart mirror 100 can include a switch for powering the smart mirror 100 on or for activating or deactivating the smart mirror from a sleep mode.

In another embodiment, the input device can include an infrared (IR) receiver 118. In some instances, the IR receiver 118 can be an IR dongle that is communicatively coupled to the controller by a length of wire for positioning the IR receiver in a position to detect an IR signal. For instance, the IR receiver 118 can detect a user input from a remote control, such as a remote control located within the guest room and configured for communication with the smart mirror 100.

The smart mirror 100 can include at least one sensor 120 for detecting information for the surroundings of the smart mirror 100. For instance, the sensor 120 can include an ambient light sensor. The controller can adjust the brightness of the display 106 or can wake the display 106 from a sleep mode upon detecting an increase in light or motion within the guest room. In a further embodiment, the smart mirror 100 can include a data port 122, such as an audio jack, Universal serial bus (USB), High-Definition Multimedia Interface (HDMI), HDMI having an Audio Return Channel compliant (ARC)). The data port 122 can be an interface to transfer data between the controller 102 and another device. In some embodiments, the smart mirror 100 can include one or more speakers 124 (e.g., stereo speakers), a microphone, or a combination thereof communicatively coupled to the controller 102.

The smart mirror 100 can include a transceiver 116 for communicating with other devices. In one or more embodiments, the transceiver 116 can be a wired or wireless transceiver including, but not limited to, an Ethernet, Bluetooth, Wi-Fi (e.g., 802.11), near field communication (NFC), or other wired or wireless transceiver. In an embodiment, the transceiver 116 can use NFC pairing to authenticate an administrator. For instance, an electronic device of the administrator can be placed within range of the NFC antenna and a communication link can be established. The controller 102 can use the NFC antenna to authenticate the electronic device of the administrator. Accordingly, administrative instructions can be communicated from the electronic device of the administrator to the controller 102. Administrative instructions can include software or firmware installations, updates, or the like. In an embodiment, the transceiver 116 can include a global positioning system (GPS) transceiver. For instance, the transceiver 116 can be in communication with a GPS system for identification of the current location of the smart mirror 100, the location of a device of the user (e.g., smart phone or tablet), or the location of another device. Accordingly, the controller 102 can receive location information from the transceiver 116.

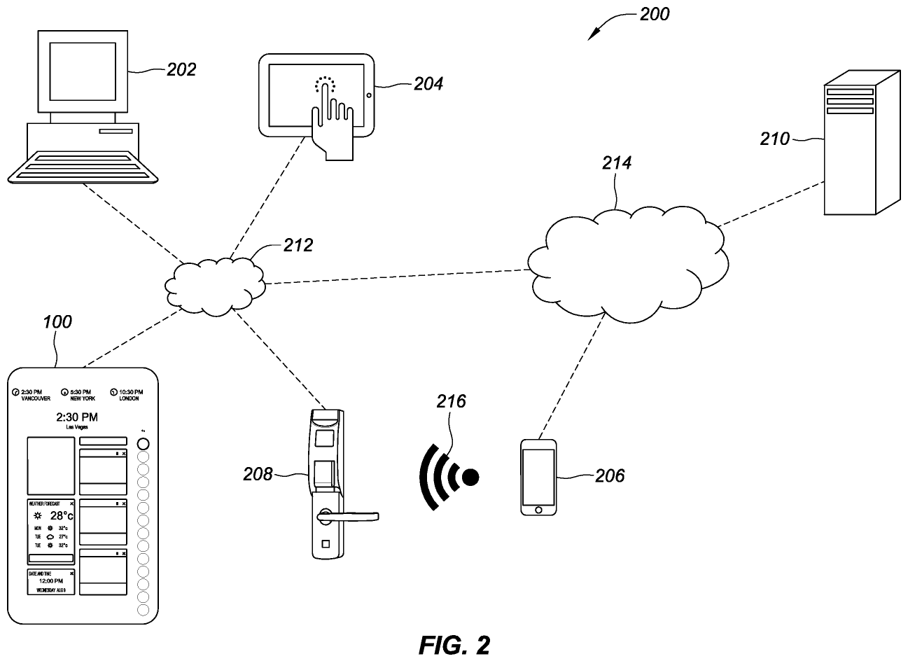

FIG. 2 illustrates an example of a system 200 including the smart mirror 100 configured for communication with a property management system 202, according to an embodiment. The system 200 can include one or more of the smart mirror 100, the property management system 202, a mobile device (e.g., a tablet 204 or a mobile phone 206), an access control system 208, a web service 210, or any combination thereof In some instances, as shown in the embodiment of FIG. 2, the controller 102 (shown in FIG. 1 and described herein) of the smart mirror 100 can be communicatively coupled with the property management system 202, the tablet 204, the mobile phone 206, or the access control system 208 through an internal network 212. As further shown in the embodiment of FIG. 2, the smart mirror 100 can be communicatively coupled to one or more mobile devices (e.g., mobile phone 206), the web service 210, or a combination thereof through an external network 214.

The internal network 212 or external network 214 can include, but are not limited to, Ethernet, Bluetooth, Wi-Fi (e.g., 802.11), wireless local area network (WLAN), NFC, ANT, wireless regional area network (WRAN), orthogonal frequency-division multiplexing (OFDM), radio-frequency identification (RFID), ultra-wideband (UWB), ZigBee, cellular network (e.g., LTE, CDMA, GSM), fiber optic network, broadband (e.g., digital subscriber line (DSL)) satellite, or the like.

The property management system 202 can include a computer system configured to manage operations of the hospitality provider. For instance, the property management system 202 can be configured to perform guest room bookings, reservations, billing, sales, event tracking, access control, housekeeping tracking, room service ordering, entertainment, internet connectivity, phone service, inventory tracking, occupancy rate tracking, performance indicator calculation, or the like. In some embodiments, the property management system 202 can communicate various parameters with the controller 102. For instance, parameters can include, but are not limited to, reservation detail (e.g., check-out time, bill, or other), access control parameters, room service parameters (e.g., food and beverage orders or usage), housekeeping parameters (e.g., cleaning times), entertainment parameters (e.g., cable television), internet parameters (e.g., connectivity information), or the like. In an example, the property management system 202 can be configured to control the smart mirror 100. For instance, the property management system 202 can power on or power off the smart mirror 100. In a further embodiment, the property management system 202 can be a workflow management system or can be communicatively coupled with a workflow management system.

The access control system 208 can include a control unit and one or more door locks operative to lock and unlock a guest room. In various embodiments, the door lock can include a reader configured to detect a keycard, pin code, biometric identifier, scanable code (e.g., barcode or matrix barcode), or the like. In some embodiments, the one or more door locks can be communicatively coupled to the control unit, such as the property management system 202 or controller 102. The door lock can receive access control parameters from the control unit (e.g., property management system 202). For instance, access control parameters can include, but are not limited to, an access control command, authentication parameters (e.g., authorized users, authorized keycards, codes, or the like), time period of valid authorization (e.g., duration of guest stay), or other authentication parameters. Accordingly, the hospitality provider or the guest can control access to the guest room (e.g., lock or unlock the guest room) through the access control system 208. In some embodiments, the guest can lock or unlock the guest room through the smart mirror 100, for instance, using the user interface 108 or the input device. In a further embodiment, the guest can authenticate a mobile device (e.g., a mobile phone 206 or a tablet 204) using the smart mirror 100 to grant authority to the mobile device for controlling access to the guest room. For instance, the mobile device 206 can be communicatively coupled to the access control system 208 (e.g., the control unit of the access control system 208) using a wireless connection 216. In various embodiments, the wireless connection 216 can include, but is not limited to, any of the examples of the internal network 212 or the external network 214 previously described herein. In another embodiment, the smart mirror 100 can receive a voice command to control access to the guest room. For instance, the guest can authenticate a voice profile using the smart mirror 100 to authorize a voice command. In yet another embodiment, a mobile device of the user can be authenticated prior to guest arrival, such as through the property management system 202.

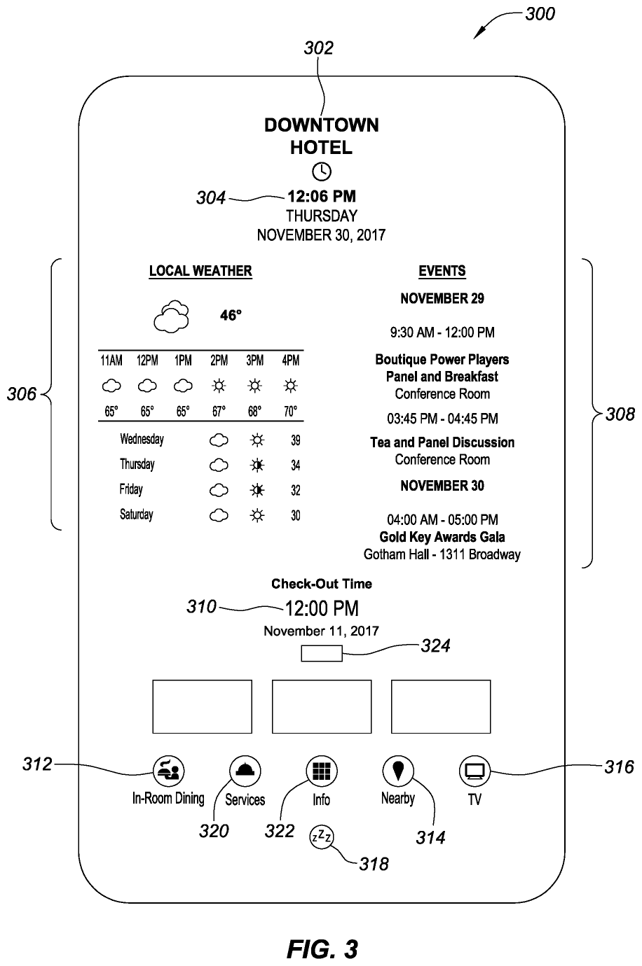

In the embodiment of FIG. 2, the smart mirror 100, property management system 202, or a combination thereof can be communicatively coupled with the web service 210. The web service 210 can provide information to the property management system 202, mobile device (e.g., mobile phone 206 or tablet 208), or smart mirror 100. In some embodiments, software or firmware updates for the smart mirror 100, one or more mobile devices, or access control system 208, can be provided from the web service 210. In another embodiment, the user interface 108 can be configured by the web service 210. For instance, the content or the layout of the user interface 108 can be provided by instructions from the web service 210. In some embodiments, the layout of the user interface 108 can include the organization of the various elements displayed in the user interface 108, such as the size, location, position with respect to other elements, colors, font size, or other display and layout parameters. Some embodiments of various layouts are illustrated in the embodiments of FIGS. 3-7 and described herein.

In various embodiments, the web service 210 can be operable to transceive location-specific information, guest data, reservation detail, hospitality service parameters, or smart mirror parameters to the smart mirror 100. In further embodiments, the web service 210 can host a third-party application (app), such as a retail, music, entertainment content, or other services application. In an example, the third-party application can provide additional services beyond those offered by the property management system 202. In further examples, the services application can include a dog walking app or a restaurant reservation app (e.g., Open table), or the like. The web services application can be downloaded to the controller 102. Accordingly, the smart mirror 100 can be operable to present or run the third-party application and display content from the third-party application. In some examples, the smart mirror 100 can be communicatively coupled with a set top box or the like. The set top box can be communicatively coupled to the web service 210 for watching television or stream content such as Hulu or Netflix one the smart mirror 100.

In another embodiment, guest data can be located on the web service 210, mobile device, or other device. Guest data can include content that is owned by or in possession of the guest, such as music, documents, video, or the like. The guest data can be communicated to the smart mirror 100 for presentation or playback. In some embodiments, the controller 102 can be configured to perform at least one of the following commands: display the guest data within the user interface, play an audio file of the guest data using speakers of the smart mirror, play a video of the guest data, or modify the guest data based on the user input.

In a further embodiment, the mobile device (e.g., the smart phone 206 or tablet 204) can be configured to communicate with or control the smart mirror 100. For instance, the mobile device can display information that is presented on the smart mirror 100. In another embodiment, the mobile device can be an input device for the smart mirror 100. Accordingly, the mobile device can present, for example, location-specific information, guest data, reservation detail, hospitality service parameters, or other information described herein. In some embodiments, the mobile device can be configured to send a command to the controller 102, property management system 202, or web service 210 to request information, hospitality services, room service, reservation detail, online shopping request, event details, interact with guest data, or the like. In another embodiment, the mobile device can be configured to access the functionality of the smart mirror 100 described herein from a location remote from the smart mirror 100. For instance, the user can access the smart mirror 100 while outside of the property, such as through the external network 214, internal network 212, or a combination thereof In some embodiments, two or more of the mobile devices can communicate with one another. For example, the mobile phone 206 and tablet 204 can be communicatively coupled. Various features of the smart mirror 100 can be accessible through the mobile device, for instance, a user interface of the mobile device can sync with the user interface 108. Upon checkout from the property or upon a command, the controller 102 can be configured to remove access of the mobile device of the guest from the smart mirror 100. In a further embodiment, the personal information of the guest (including the gest data) can be removed from the smart mirror 100 upon checkout to secure the personal information of the guest and the guest data.

In some embodiments, one or more of the property management system 202, mobile devices (e.g., tablet 204 or mobile phone 206), access control system 208, web service 210, or other component of the system 200 can include a controller, such as controller 102, having logic device. As previously described the logic device can include one or more sets of processing instructions stored thereon. For instance, the processing instructions can include one or more operating systems including, but not limited to, Android, Microsoft Windows, Apple IOS, Raspberry Pi Raspbian, or the like. One or more of the various components of the system, such as the property management system 202, mobile devices (e.g., tablet 204 or mobile phone 206), access control system 208, or web service 210 can communicate with one another or can be configured to execute instructions using the operating system. In an embodiment, each of the property management system 202, mobile devices (e.g., tablet 204 or mobile phone 206), access control system 208, and web service 210 can include the Android operating system.

In a further embodiment, the system 200 can include a remotely controllable lighting module, thermostat, window coverings, or the like. For instance, the remotely controllable lighting module, thermostat, or window coverings can be internet-of-things devices. The controller 102 can be configured to communicate with one or more of the remotely controllable lighting module, thermostat, or window coverings. For instance, the controller 102 can be configured to operate one or more of the remotely controllable lighting module, thermostat, or window coverings based on the user input from the input device, such as the touch-panel overlay 110. Various control icons and options of the remotely controllable lighting module, thermostat, or window coverings can be presented in the user interface 108.

FIG. 3 is a depiction of an example of a user interface 300 of the smart mirror 100 (shown in FIG. 1 and described herein) including a home screen presented in the user interface 300, in accordance with an embodiment. In an embodiment, the user interface 300 can include location-specific information, reservation detail 310, room service icon 312, hospitality service icon 320, information icon 322, map icons 314, entertainment icons 316, or the like. In the embodiment of FIG. 3, hospitality provider name 302 as well as the date and time 304 can be presented at the top portion of the user interface 300. Location-specific information can include information that is associated with the location of the system 200, smart mirror 100, or the property management system 202. In some embodiments, location-specific information can include, but is not limited to, one or more of local weather 306 information, geographic location, a local event list 308, or the like. In an embodiment, the location-specific information can be presented in the middle portion of the user interface 300. Reservation detail 310 can be located underneath the location-specific information. Reservation detail 310 can include checkout day, checkout time, billing, or other information relating to the current reservation of the guest. In an embodiment, the reservation detail 310 can include an reservation modification icon 324 displayed on the home screen of the user interface 300. For instance, the reservation modification icon 324 can be displayed adjacent to the reservation detail 310. The reservation modification icon 324 can be used by the guest to change one or more aspects of the reservation, such as checkout time or checkout date.

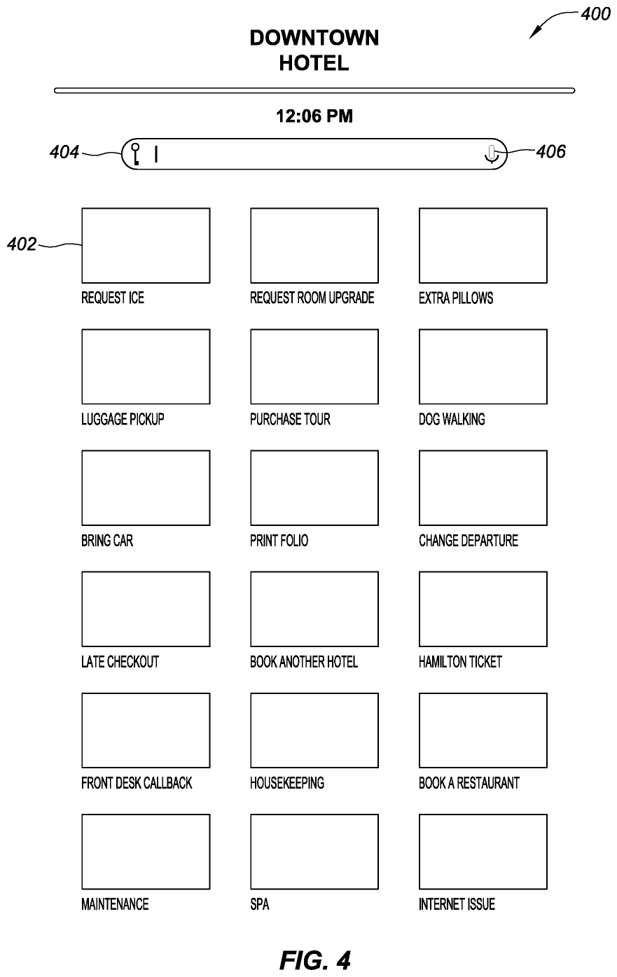

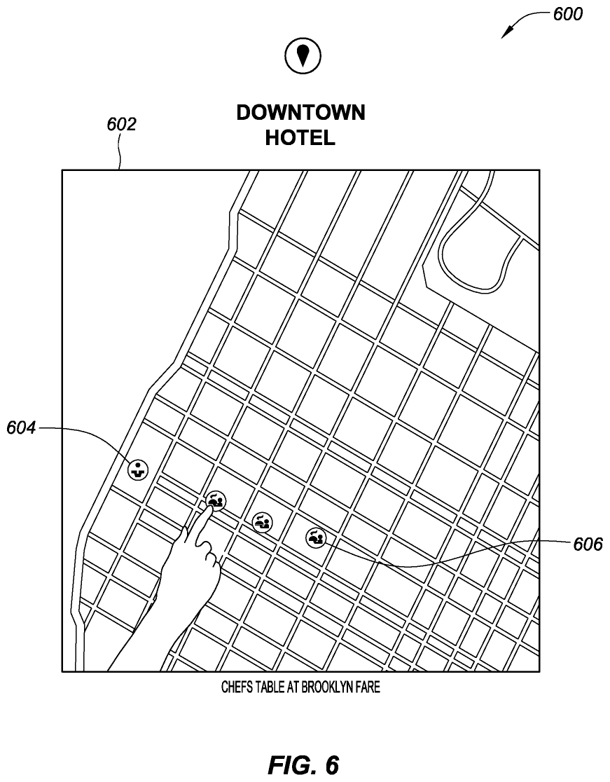

As shown in the embodiment of FIG. 3, one or more icons can be located along the lower portion of the user interface 300. For instance, the user interface 300 can include, but is not limited to, any one or more of the following: the hospitality service icon 320, the room service icon 312, the information icon 322, the location-specific map icon 314, the entertainment icon 316 (e.g., TV), an alarm clock icon, a sleep mode icon 318, or the like. The hospitality service icon 320 can link to various hospitality services of the hospitality provider as described further herein and shown in FIG. 4. The information icon 322 can include details of the hospitality service property, such as the amenities, on location restaurants and bars, floor plan, emergency procedures, contact information, or the like. In a further embodiment, the user interface 300 can include a link to a phone icon for operating an internet telephone function or a link to audio or video chat. The location-specific map 314 can link to a user interface (e.g., as shown in FIG. 6 and described further herein) depicting the locations of local events, restaurants, bars, museums, points-of-interest, attractions, the hospitality provider location, or other locations. In various embodiments, the entertainment icon 316 can link to television, movies, music, games, fitness programs, or other entertainment services. The sleep mode icon 318 can turn off the user interface 300 to place the smart mirror 100 in a sleep mode. Accordingly, the smart mirror 100 can function as a traditional mirror. In various embodiments, the icons, such as the hospitality service icon 320, room service icon 312, information icon 322, location-specific map icon 314, entertainment icon 316 (e.g., TV), alarm clock icon, or sleep mode icon 318 icons, can be selectable soft keys within the user interface 300. For example, the soft keys can be selectable through a touch screen display, touch-panel overlay 110, or by using an input device.

In an embodiment, the size and shape of the user interface 300 can be adjustable by a user input from the guest. The user input can include, but is not limited to, a user input from the touch screen display, touch-panel overlay 110, input device, a voice command, or a command from the property management system 202, controller 102, web service 210, or other source. Accordingly, the user interface 300 can be configured to cover a large portion of the semi-transparent mirror panel 104 or a small segment of the semi-transparent mirror panel 104. In a further embodiment, the user interface 300 can be positioned at various locations and orientations of the semi-transparent mirror panel 104. For instance, the user interface 300 can be rotated (e.g., 90 degrees) to accommodate portrait or landscape orientations of the smart mirror 100.

FIG. 4 is an illustration of an example of a user interface 400 including a hospitality services menu, according to an embodiment. In an embodiment, the user interface 400 can be accessible through selection of the hospitality services icon 320 on the user interface 300 (e.g., home screen) shown in FIG. 3. As previously described, selection of the hospitality services icon 320 can be through a touch-screen display, a touch-panel overlay 110, or through an input device (e.g., remote control). The user interface 400 can include one or more hospitality icons 402 configured to link to hospitality services for communicating corresponding hospitality service requests. In the embodiment of FIG. 4, the user interface 400 includes a plurality of hospitality icons 402 arranged in a grid pattern. The smart mirror 100 can be configured to obtain various hospitality services from the property management system 202 and present the hospitality services in a hospitality services menu in the user interface 400, as shown in FIG. 4.

In some embodiments, the hospitality icons 402 can be configured to send a service request to the property management system 202 based on the user input. As shown in the embodiment of FIG. 4, the hospitality icons 402 and corresponding service requests can include, but are not limited to, a request for ice, room upgrade, extra pillows, luggage pickup, tour purchase, dog walking, car valet, remote office services (e.g., printing), change checkout date, late checkout, book another hotel, purchase a ticked for an event, list of events, details of events within a specified range of the smart mirror 100, call front desk, housekeeping, book a restaurant reservation, maintenance, spa reservation, technical support, or the like. The user interface 400 can optionally include a search bar 404. The search bar 404 can be used to keyword search the hospitality services. The search bar 404 can receive user input from the input device (e.g., remote, touch-screen, touch-panel overlay). In an embodiment, the search bar 404 can include a voice search icon 406. The guest can activate a voice-based search by selected in the voice search icon 406.

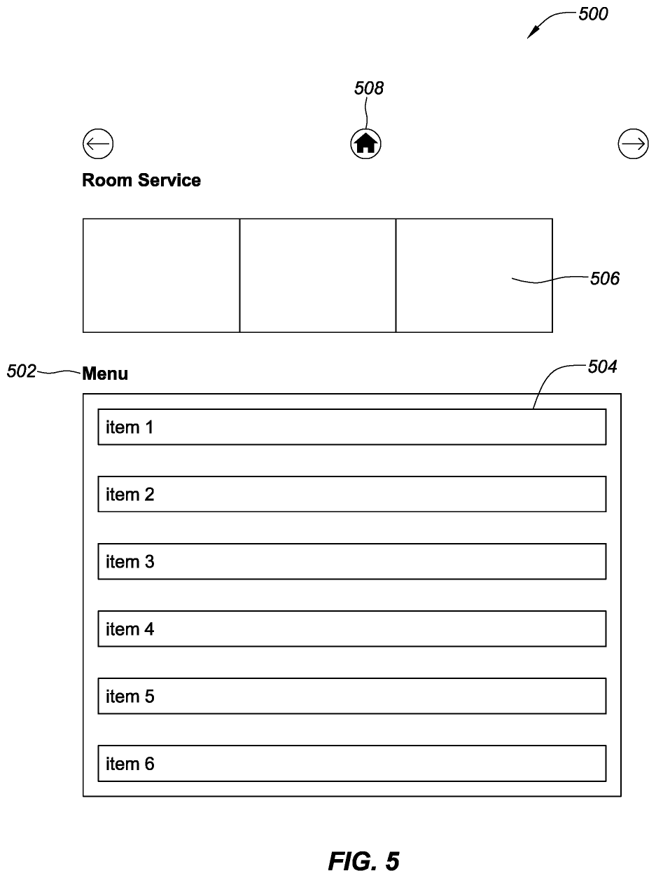

FIG. 5 is an illustration of an example of a user interface 500 including a room service screen. In some embodiments, the user interface 500 can be accessible through the room service icon 312 presented in the user interface 300 (e.g., home screen as shown in FIG. 3). In another embodiment, the user interface 500 can be accessible through the hospitality service user interface 400. The user interface 500 can include a room service menu 502 and at least one menu icon 504. The menu icon 504 can correspond with an item on the room service menu 502 and can be selected by the user input to generate an order selection request. The room service menu 502 can include various details of the menu items, such as a description of the item, cost, nutritional information, or the like. In some embodiments, the user interface 500 can include one or more images 506 of an item (e.g., represented by a menu icon 504) on the room service menu 502. For instance, in the embodiment of FIG. 5, the image 506 can be presented above the room service menu 502. In an embodiment, a home screen icon 508 can be located in the user interface 500, such as at the top of the user interface 500 to link back to the home screen user interface 300.

FIG. 6 is an illustration of an example of a map interface 600 presented by the smart mirror 100, according to an embodiment. The map interface 600 can be accessible through the map icon 314 on the home screen (e.g., user interface 300). The map interface 600 can include a map 602. The map 602 can be configured to depict the area surrounding a geographic location 604 of the smart mirror 100. For instance, the map 600 can depict a range of one mile, five miles, ten miles, or other distance surrounding the geographic location 604 of the smart mirror 100.

In an embodiment, the map 602 can indicate one or more locations of interest 606 within the range of the smart mirror 100. In various embodiments, the location of interest 606 can include, but is not limited to, a location of one or more nearby events, restaurants, local businesses, attractions, or the like. For instance, the location of interest 606 can be indicated with respect to the geographic location 604. In some embodiments, the location of interest 606 can correspond to the local events 308 presented in the user interface 300 (e.g., home screen).

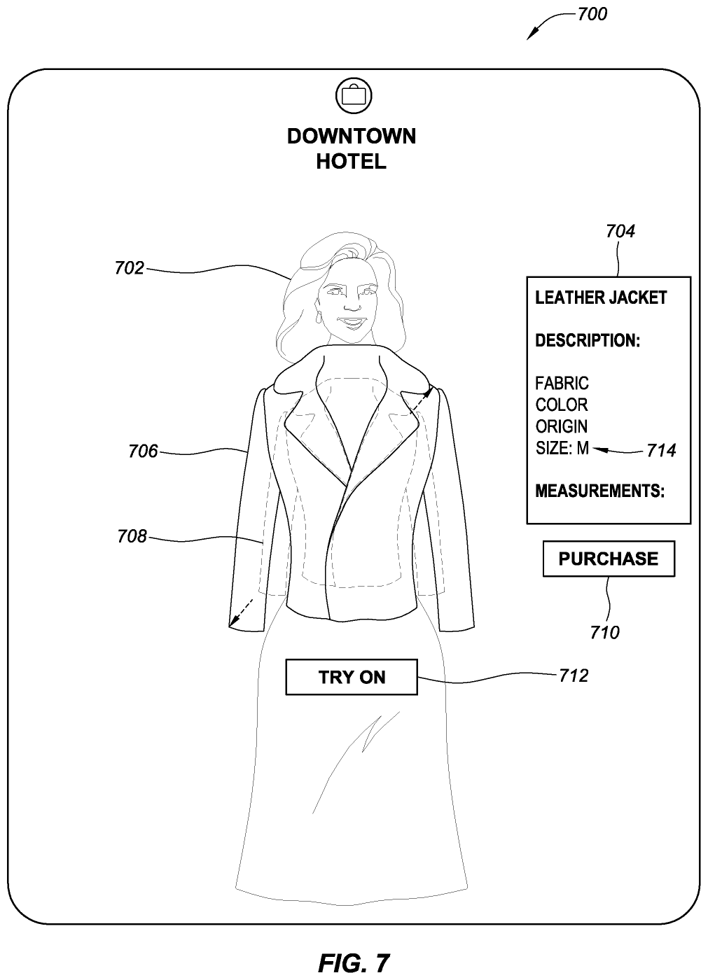

FIG. 7 is an example of a user interface 700 (online shopping interface) presented on the display 106 of the smart mirror 100, according to an embodiment. The controller 102 can obtain clothing parameters from the web service 210 or the property management system 202. Accordingly, the smart mirror 100 can present on the display 106 a representation of an article of clothing 706 based on the clothing parameters. In the embodiment of FIG. 7, the representation of the article of clothing 706 is presented to overlap with a reflection of the user 702 for simultaneous viewing. Clothing details 704 can be presented alongside of the representation of the article of clothing 706, for instance, above, below, to the left, or to the right of the representation of the article of clothing 706. Clothing details 704 can be based on the clothing parameters and can include, but are not limited to, information about the article of clothing, such as a description, fabric type, origin, measurements, size, store availability, colors, alternative views, or other details.

A purchase icon 710 can be presented in the user interface 700. Accordingly, the guest can select the purchase icon 710 to purchase the article of clothing based on a user input. Selection of the purchase icon 710 can transmit a request for the purchase of the article of clothing to an order system of a retailer. For instance, the request can be transmitted to the property management system 202 for order processing or the request can be transmitted to the retailer (e.g., through the web service 210 in some instances). In an embodiment, the web service 210 can include the order system of the retailer. In various embodiments, payment can be processed by the property management system 202 and added to bill of the guest, payment can be entered by a user input at the smart mirror 100, or payment can be made by another payment method. In some embodiments, the article of clothing, once purchased, can then be available for pick up at a nearby location (the location optionally presented in the map interface 600), can be delivered to the hospitality provider (e.g., front desk), or can be delivered directly to the guest room.

In the embodiment of FIG. 7, the user interface 700 includes a Try On icon 712. Upon selection of the Try On icon 712 by the user input, the representation of the article of clothing 706 can be scaled by the guest. For instance, the controller 102 can generate a scaled representation 708 of the article of clothing based on the user input. In an embodiment, the user input can include a gesture received by the touch-screen display or touch-panel overlay, a gesture detected by an optical sensor through one or more input devices, or a selection received by another input device. Accordingly, the guest can scale the representation of the article of clothing 706. For instance, the guest can scale the representation of the article of clothing 706 so the appearance of the scaled representation 708 fits the reflection of the user 702. Thus, by selecting the Try On icon 712 the guest can view an approximation of how they would look wearing the article of clothing. In other words, the user interface 700 can be used as a virtual fitting room.

In a further embodiment, the controller 102 can be configured to calculate a size of the article of clothing based on the scaled representation 708. An indication of the size 714 can be presented in the user interface 700. In some embodiments, the indication of the size 714 can be calculated by the controller 102 based on the size of scaled representation 708 of the article of clothing. In a further embodiment, one or more input devices of the smart mirror 100 can include at least one sensor, such as an optical or a laser sensor, for measuring the size of the guest and calculating the corresponding indicated size of the of scaled representation 708.

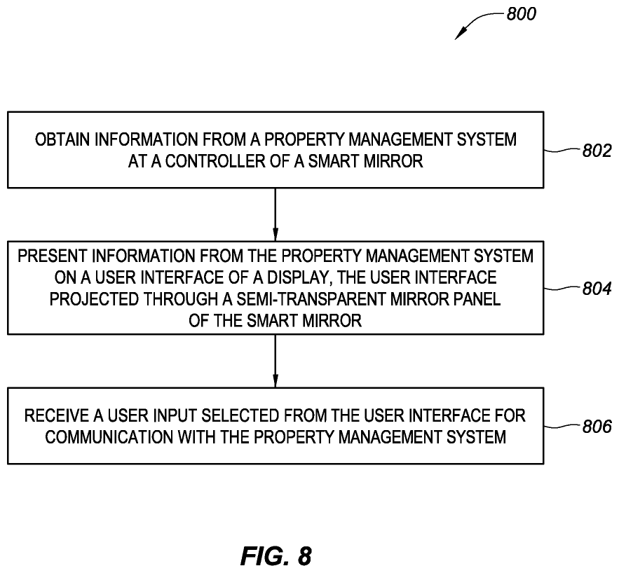

FIG. 8 is an example of a method 800 of controlling a smart mirror, such as the smart mirror 100 previously described in the embodiments herein and shown for instance in FIGS. 1-7. In describing the method 800, reference is made to one or more components, features, functions, and processes previously described herein. Where convenient, reference is made to the components, features, processes and the like with reference numerals. Reference numerals provided are exemplary and are nonexclusive. For instance, features, components, functions, processes, and the like described in the method 800 include, but are not limited to, the corresponding numbered elements provided herein. Other corresponding features described herein (both numbered and unnumbered) as well as their equivalents are also considered.

At 802, information can be obtained at a controller (e.g., controller 102) from a property management system, such as property management system 202. The controller can be communicatively coupled with a smart mirror (e.g., smart mirror 100) having a semi-transparent mirror panel, such as the semi-transparent mirror panel 104. The information can be obtained by wire or wirelessly through a network (e.g., internal network 212 or external network 214) using one or more transceivers (e.g., transceiver 116). Information can include, but is not limited to, location-specific information, room service information, guest data, reservation detail, hospitality service parameters, online shopping information, smart mirror parameters, other information described herein, or the like.

At 804, information from the property management system can be presented on a user interface (e.g., user interface 108) of a display, such as display 106. In an embodiment, presenting the user interface can include projecting the user interface through a semi-transparent mirror panel. In an embodiment, a layout of the user interface can be obtained from a web service, such as web service 210. In other instances, the layout of the user interface can be determined in whole or in part by the controller. For instance, the controller can include instructions for the layout. The instructions can be stored within the memory of the controller.

In various embodiments, presenting information from the property management system on the user interface can include presenting location-specific information from the property management system. For instance, presenting location-specific information can include rendering a map (e.g., map interface 600) including locations of interest within a specified range of the smart mirror. In some embodiments, the location-specific information can include, but is not limited to, one or more of weather information, geographic location field, time, a local event list, other location-specific information described herein, or the like. Presenting information on the user interface can include rendering a list of event details within the specified range of the smart mirror. In some embodiments, presenting information on the user interface can include presenting reservation detail from the property management system on the display. For instance, the reservation detail can include, but is not limited to, a checkout day or a checkout time. In an embodiment, presenting information can include presenting one or more hospitality service icons in the user interface. The hospitality service icons can be configured to link to hospitality services and for selecting various hospitality service requests.

At 806, a user input (e.g., selected from the display) can be received at the smart mirror for communication with the property management system. For instance, an icon or selection can be presented on the display for selection by the guest. User input can be received using an input device as described herein. For instance, the user input can be received from a touch-screen display, a touch-panel overlay (e.g., touch-panel overlay 110), remote control, mobile device (e.g., tablet or mobile phone), microphone (e.g., for an voice command), or other input device. The user input can correspond with a selection or icon presented on the display. In some embodiments, guest data can be received from a mobile device, such as a mobile phone of the user. Guest data can include, but is not limited to, music, documents, video, or the like. The user can present the guest data on the display (e.g., in the user interface of the display), listen to the guest data, or modify the guest data using the smart mirror.

In an embodiment, the input selected from the display can include a service request for transmission to the property management system. In various embodiments the service request can include, but is not limited to, a request for ice, room upgrade, extra pillows, luggage pickup, tour purchase, dog walking, car valet, remote office services (e.g., printing), change checkout, late checkout, book another hotel, purchase a ticked for an event, list of events, list of event details within a specified range of the smart mirror 100, call front desk, housekeeping, book a restaurant reservation, maintenance, spa reservation, technical support, or the like.

In a further embodiment, receiving the user input can include receiving access control parameters for use with controlling access to a guest room. For instance access to a guest room can be provided through an access control system, such as the access control system 208. Access control parameters can include, but are not limited to, authentication information, command to lock or unlock, grant access to a specified user, grant access to a mobile device of a user, configure a mobile device of a user for granting an access command, authenticate a mobile device for granting an access command. In an embodiment, the user input can include validation information to authenticate a guest. A lock or unlock command can be transmitted to the access control system based on successful authentication.

The mobile device can be communicatively coupled to the controller through the wireless network. In some embodiments, the mobile device can be authenticated with the smart mirror, the access control system, or the like. The mobile device can be authenticated using the smart mirror, for instance, authentication can be provided based on the user input. Accordingly, a lock or unlock command can be sent from the mobile device to control access to the guest room. In another embodiment, instructions can be received at the controller from the mobile device to present information on the display (e.g., guest data) or transmit a command to the controller (e.g., a user input).

In a further embodiment, clothing parameters can be obtained from a web service and presented on the display. For instance, a representation of an article of clothing (e.g., representation of the article of clothing 706 as shown in FIG. 7) based on the clothing parameters can be presented on the display. In an embodiment, the clothing parameters (e.g., clothing details 704) can be presented alongside the representation of the article of clothing in the display. The representation of the article of clothing can be presented to overlap with a reflection of the user for simultaneous viewing. In some embodiments, the representation of the article of clothing can be scaled based on the user input. For instance, the representation of the article of clothing can be made to appear larger or smaller based on the user input. In an embodiment, the controller can be configured to calculate a size of the article of clothing. An indication (indication of size 714) of the calculated size can be presented on the display. For instance, the controller can determine that the scaled representation of the article of clothing (e.g., scaled representation 708) would correspond to a size small, medium, large, or other size and present the indication of size on the display.

In a further embodiment, a command can be transmitted to a remotely controllable lighting module, thermostat, window coverings, or the like. For instance, the command can be transmitted over a network connection to remotely controllable lighting module, thermostat, or window coverings. For instance, the remotely controllable lighting module, thermostat, or window coverings can be internet-of-things devices. The controller 102 can be configured to communicate with one or more of the remotely controllable lighting module, thermostat, or window coverings. For instance, the controller 102 can be configured to operate one or more of the remotely controllable lighting module, thermostat, or window coverings based on the user input from the input device, such as the touch-panel overlay 110. Various control icons and options of the remotely controllable lighting module, thermostat, or window coverings can be presented in the user interface 108.

In some embodiments, instructions can be communicated between the controller and a third-party application. For instance, the third party application can be configured to provide services on the smart mirror. In various embodiments, the third party application can include an order system of a retailer, restaurant, event venue, attraction, or the like. For instance, receiving the user input can include receiving a request to purchase the article of clothing from an order system of a retailer.

### VARIOUS NOTES AND EXAMPLES

Each of these non-limiting examples may stand on its own, or may be combined in various permutations or combinations with one or more of the other examples. To better illustrate the method and apparatuses disclosed herein, a non-limiting list of embodiments is provided here:

Example 1 is a smart mirror for operating a virtual hospitality service, the smart mirror comprising: a controller configured for communication with a property management system; a semi-transparent mirror panel; and a display configured to render a user interface for projection through the semi-transparent mirror panel, the user interface adapted to: present information from the property management system, and receive a user input from an input device for communication with the property management system.

In Example 2, the subject matter of Example 1 optionally includes wherein the display is further configured to present location-specific information from the property management system on the user interface, the location-specific information including a map displaying locations of interest within a specified range of the smart mirror.

In Example 3, the subject matter of any one or more of Examples 1-2 optionally include wherein the display is further configured to present a list of event details within a specified range of the smart mirror.

In Example 4, the subject matter of any one or more of Examples 1-3 optionally include wherein the controller is configured to obtain reservation detail from the property management system and present the reservation detail from the property management system in the user interface of the display.

In Example 5, the subject matter of any one or more of Examples 1-4 optionally include wherein the display is further configured to present at least one hospitality service obtained from the property management system, and wherein the display is adapted to generate a service request for transmission to the property management system based on the user input.

In Example 6, the subject matter of any one or more of Examples 1-5 optionally include wherein the controller is configured to receive a layout of the user interface from a web service, and the display is configured to present the user interface based on the layout.

In Example 7, the subject matter of any one or more of Examples 1-6 optionally include wherein the controller is configured to obtain clothing parameters from a web service and present a representation of an article of clothing on the display, the representation of the article of clothing based on the clothing parameters, wherein the representation of the article of clothing is adapted for presentation to overlap with a reflection of the user for simultaneous viewing.

In Example 8, the subject matter of Example 7 optionally includes wherein the user input includes a request to purchase the article of clothing from an order system of a retailer.

In Example 9, the subject matter of any one or more of Examples 7-8 optionally include wherein the controller is configured to generate a scaled representation of the article of clothing based on the user input.

In Example 10, the subject matter of Example 9 optionally includes wherein the controller is configured to calculate a size of the article of clothing based on the scaled representation and present an indication of the size on the display.

In Example 11, the subject matter of any one or more of Examples 1-10 optionally include wherein the controller is configured for communication with an access control system and to provide access control parameters for controlling access to a guest room associated with the property management system.

In Example 12, the subject matter of Example 11 optionally includes wherein the controller is configured for communication with a mobile device of a user to present information on the display or to transmit a command to the controller, wherein the mobile device is adapted to be in communication with the controller through a wireless network.

In Example 13, the subject matter of Example 12 optionally includes wherein the mobile device is configured to send a lock or unlock command to an access control system of a guest room.

In Example 14, the subject matter of any one or more of Examples 1-13 optionally include wherein the controller is configured to communicate instructions with a third-party application for providing services on the smart mirror through the third-party application.

In Example 15, the subject matter of any one or more of Examples 1-14 optionally include wherein the input device is a touch-panel overlay located on the semi-transparent mirror panel, and the touch-panel overlay is configured to communicate the user input to the controller.

In Example 16, the subject matter of any one or more of Examples 1-15 optionally include wherein the input device includes one or more pushbutton switches.

In Example 17, the subject matter of any one or more of Examples 1-16 optionally include wherein the input device is an infrared dongle configured to detect input signals and transmit a command to the controller.

In Example 18, the subject matter of any one or more of Examples 1-17 optionally include wherein the controller is configured to receive guest data from a mobile device of a user, and the controller is further configured to perform at least one of the following commands: display the guest data within the user interface, play an audio file of the guest data using speakers of the smart mirror, or modify the guest data based on the user input.

In Example 19, the subject matter of any one or more of Examples 1-18 optionally include wherein the smart mirror is supported within a cabinet configured for coupling to a wall.

Example 20 is a system comprising: a property management system; and a smart mirror communicatively coupled to the property management system, the smart mirror including: a controller configured for communication with the property management system; a semi-transparent mirror panel; and a display configured to render a user interface for projection through the semi-transparent mirror panel, the user interface adapted to: present information from the property management system, and receive a user input from an input device for communication with the property management system.

In Example 21, the subject matter of Example 20 optionally includes wherein the display is further configured to present location-specific information from the property management system on the user interface, the location-specific information including a map displaying locations of interest within a specified range of the smart mirror.

In Example 22, the subject matter of any one or more of Examples 20-21 optionally include wherein the display is further configured to present a list of event details within a specified range of the smart mirror.

In Example 23, the subject matter of any one or more of Examples 20-22 optionally include wherein the controller is configured to obtain reservation detail from the property management system and present the reservation detail from the property management system in the user interface of the display.

In Example 24, the subject matter of any one or more of Examples 20-23 optionally include wherein the display is further configured to present a hospitality service obtained from the property management system, and wherein the display is adapted to generate a service request for transmission to the property management system based on the user input.

In Example 25, the subject matter of any one or more of Examples 20-24 optionally include wherein the controller is configured to receive a layout of the user interface from a web service, and the display is configured to present the user interface based on the layout.

In Example 26, the subject matter of any one or more of Examples 20-25 optionally include wherein the controller is configured to obtain clothing parameters from a web service and present on the display a representation of an article of clothing based on the clothing parameters, wherein the representation of the article of clothing is adapted for presentation to overlap with a reflection of the user for simultaneous viewing.

In Example 27, the subject matter of Example 26 optionally includes wherein the user input includes a request to purchase the article of clothing from an order system of a retailer.

In Example 28, the subject matter of any one or more of Examples 26-27 optionally include wherein the controller is configured to generate a scaled representation of the article of clothing based on the user input.

In Example 29, the subject matter of Example 28 optionally includes wherein the controller is configured to calculate a size of the article of clothing based on the scaled representation and present an indication of the size on the display.

In Example 30, the subject matter of any one or more of Examples 20-29 optionally include an access control system wherein the controller is configured for communication with the access control system and to provide access control parameters for controlling access to a guest room associated with the property management system.

In Example 31, the subject matter of Example 30 optionally includes wherein the controller is configured for communication with a mobile device of a user to present information on the display or transmit a command to the controller, wherein the mobile device is adapted to be in communication with the controller through a wireless network.

In Example 32, the subject matter of Example 31 optionally includes wherein the mobile device is configured to send a lock or unlock command to the access control system of a guest room.

In Example 33, the subject matter of any one or more of Examples 20-32 optionally include wherein the controller is configured to communicate instructions with a third-party application for providing services on the smart mirror through the third-party application.

In Example 34, the subject matter of any one or more of Examples 20-33 optionally include wherein the input device includes a touch-panel overlay located on the semi-transparent mirror panel, and the touch-panel overlay is configured to communicate user input to the controller.

In Example 35, the subject matter of any one or more of Examples 20-34 optionally include wherein the input device includes one or more pushbutton switches.

In Example 36, the subject matter of any one or more of Examples 20-35 optionally include wherein the user interface is an infrared dongle configured to detect input signals and transmit a command to the controller.

In Example 37, the subject matter of any one or more of Examples 20-36 optionally include wherein the controller is configured to receive guest data from a mobile device of a user, and the controller is further configured to perform at least one of the following commands: display the guest data within the user interface, play an audio file of the guest data using speakers of the smart mirror, or modify the guest data based on the user input.

Example 38 is a user interface for a smart mirror, the user interface comprising: location-specific information including one or more of weather information, geographic location, time, or a local event list; reservation detail including checkout day and checkout time; and at least one hospitality service icon configured to link to a hospitality service and adapted for communicating a corresponding hospitality service request; wherein, the location-specific information, reservation detail, and hospitality service icon are arranged for viewing on a home screen of the user interface.

In Example 39, the subject matter of Example 38 optionally includes a map indicating the location of local events, the local events corresponding to the local events list displayed on the home screen, and the map accessible through a map icon on the home screen.

In Example 40, the subject matter of any one or more of Examples 38-39 optionally include a map indicating the location of local businesses, the map accessible through a map icon on the home screen.

In Example 41, the subject matter of any one or more of Examples 38-40 optionally include wherein a room service menu is accessible from the home screen, the room service menu including at least one menu icon, wherein the menu icon is configured to send a menu order request based on a user input.

In Example 42, the subject matter of any one or more of Examples 38-41 optionally include an online shopping interface, the online shopping interface configured to present and scale a representation of an article of clothing based on a user input.

In Example 43, the subject matter of Example 42 optionally includes wherein an indication of a size is calculated based on the size of the scaled representation of the article of clothing, and the indication of the size is presented in the user interface.

In Example 44, the subject matter of Example 43 optionally includes wherein a purchase selection is presented in the user interface along with the representation of the article of clothing and the indication of size.

In Example 45, the subject matter of any one or more of Examples 38-44 optionally include a reservation modification icon displayed on the home screen adjacent to reservation detail, wherein the reservation modification icon is configured for changing one or more aspects of the reservation detail.

In Example 46, the subject matter of any one or more of Examples 38-45 optionally include wherein a hospitality service menu is accessible from the home screen, the hospitality service menu including at least one hospitality service icon, wherein the hospitality service icon is configured to send the hospitality service request based on a user input.

In Example 47, the subject matter of any one or more of Examples 38-46 optionally include wherein a remote office service menu for selecting an office service request is accessible through the hospitality service icon.

In Example 48, the subject matter of any one or more of Examples 38-47 optionally include wherein the hospitality service icon includes a link to select a technical support request.

In Example 49, the subject matter of any one or more of Examples 38-48 optionally include wherein the home screen includes a link to a phone icon for operating an internet telephone function.

In Example 50, the subject matter of any one or more of Examples 38-49 optionally include wherein the home screen includes a link to a sleep mode icon.

Example 51 is a method for controlling a smart mirror, the method comprising: obtaining information at a controller from a property management system, wherein the controller is communicatively coupled with a smart mirror having a semi-transparent mirror panel; presenting information from the property management system on a user interface of a display, wherein the display is configured to project the user interface through the semi-transparent mirror panel; and receiving a user input for communication with the property management system.

In Example 52, the subject matter of Example 51 optionally includes wherein presenting information from the property management system on the user interface includes obtaining location-specific information from the property management system and rendering a map including a location of interest within a specified range of the smart mirror.

In Example 53, the subject matter of any one or more of Examples 51-52 optionally include wherein presenting information from the property management system on the user interface includes rendering a list of event details within a specified range of the smart mirror.

In Example 54, the subject matter of any one or more of Examples 51-53 optionally include wherein presenting information from the property management system on the user interface includes obtaining reservation detail from the property management system and presenting the reservation detail on the display.

In Example 55, the subject matter of any one or more of Examples 51-54 optionally include wherein presenting information from the property management system includes rendering a hospitality service obtained from the property management system, and wherein receiving the user input includes a service request, wherein the service request is transmitted to the property management system.

In Example 56, the subject matter of any one or more of Examples 51-55 optionally include obtaining a layout of the user interface from a web service.

In Example 57, the subject matter of any one or more of Examples 51-56 optionally include obtaining clothing parameters from a web service, presenting on the display a representation of an article of clothing based on the clothing parameters, wherein the representation of the article of clothing is presented to overlap with a reflection of the user for simultaneous viewing.

In Example 58, the subject matter of Example 57 optionally includes scaling the representation of the article of clothing based on the user input.

In Example 59, the subject matter of any one or more of Examples 57-58 optionally include wherein the controller is configured to calculate a size of the article of clothing and present an indication of the size on the display.

In Example 60, the subject matter of any one or more of Examples 57-59 optionally include wherein receiving the user input includes a request to purchase the article of clothing from an order system of a retailer.

In Example 61, the subject matter of any one or more of Examples 51-60 optionally include wherein receiving the user input includes receiving access control parameters for use with controlling access to a guest room through an access control system.

In Example 62, the subject matter of Example 61 optionally includes wherein receiving access control parameters includes receiving an access command, and the smart mirror is configured to send the access command to the access control system for controlling access to the guest room.

In Example 63, the subject matter of any one or more of Examples 51-62 optionally include receiving, at the controller, instructions from a mobile device of a user to present information on the display or to transmit a command to the controller, wherein the mobile device is adapted for communication with the controller through a wireless network.

In Example 64, the subject matter of Example 63 optionally includes wherein the mobile device is configured to send a lock or an unlock command to an access control system of a guest room.

In Example 65, the subject matter of any one or more of Examples 51-64 optionally include communicating instructions between the controller and a third-party application for providing services on the smart mirror through the third-party application.

In Example 66, the subject matter of any one or more of Examples 51-65 optionally include wherein receiving the user input includes receiving input from a touch-panel overlay located on the semi-transparent mirror panel.

In Example 67, the subject matter of any one or more of Examples 51-66 optionally include receiving guest data from a mobile device, wherein the user can present the guest data on the display, listen to the guest data, or modify the guest data.

Each of these non-limiting examples can stand on its own, or can be combined in various permutations or combinations with one or more of the other examples.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

It will be further appreciated that for conciseness and clarity, spatial terms such as “vertical,” “horizontal,” “up,” and “down” may be used herein with respect to the illustrated embodiments. However, the examples discussed herein may be used in many orientations and positions, and these terms are not intended to be limiting and absolute.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A smart mirror for operating a virtual hospitality service, the smart mirror comprising:
a controller configured for communication with a property management system;
a semi-transparent mirror panel; and
a display configured to render a user interface for projection through the semi-transparent mirror panel, the user interface adapted to:
present information from the property management system, and
receive a user input from an input device for communication with the property management system.

2. The smart mirror of claim 1, wherein the display is further configured to present location-specific information from the property management system on the user interface, the location-specific information including a map displaying locations of interest within a specified range of the smart mirror.

3. The smart mirror of claim 1, wherein the display is further configured to present a list of event details within a specified range of the smart mirror.

4. The smart mirror of claim 1, wherein the controller is configured to obtain reservation detail from the property management system and present the reservation detail from the property management system in the user interface of the display.

5. The smart mirror of claim 1, wherein the display is further configured to present at least one hospitality service obtained from the property management system, and wherein the display is adapted to generate a service request for transmission to the property management system based on the user input.

6. The smart mirror of claim 1, wherein the controller is configured to receive a layout of the user interface from a web service, and the display is configured to present the user interface based on the layout.

7. The smart mirror of claim 1, wherein the controller is configured to obtain clothing parameters from a web service and present a representation of an article of clothing on the display, the representation of the article of clothing based on the clothing parameters, wherein the representation of the article of clothing is adapted for presentation to overlap with a reflection of the user for simultaneous viewing.

8. The smart mirror of claim 7, wherein the user input includes a request to purchase the article of clothing from an order system of a retailer.

9. The smart mirror of claim 7, wherein the controller is configured to generate a scaled representation of the article of clothing based on the user input.

10. The smart mirror of claim 9, wherein the controller is configured to calculate a size of the article of clothing based on the scaled representation and present an indication of the size on the display.

11. The smart mirror of claim 1, wherein the controller is configured for communication with an access control system and to provide access control parameters for controlling access to a guest room associated with the property management system.

12. The smart mirror of claim 11, wherein the controller is configured for communication with a mobile device of a user to present information on the display or to transmit a command to the controller, wherein the mobile device is adapted to be in communication with the controller through a wireless network.

13. The smart mirror of claim 12, wherein the mobile device is configured to send a lock or unlock command to an access control system of a guest room.

14. The smart mirror of claim 1, wherein the controller is configured to communicate instructions with a third-party application for providing services on the smart mirror through the third-party application.

15. The smart mirror of claim 1, wherein the input device is a touch-panel overlay located on the semi-transparent mirror panel, and the touch-panel overlay is configured to communicate the user input to the controller.

16. The smart mirror of claim 1, wherein the input device includes one or more pushbutton switches.

17. The smart mirror of claim 1, wherein the input device is an infrared dongle configured to detect input signals and transmit a command to the controller.

18. The smart mirror of claim 1, wherein the controller is configured to receive guest data from a mobile device of a user, and the controller is further configured to perform at least one of the following commands: display the guest data within the user interface, play an audio file of the guest data using speakers of the smart mirror, or modify the guest data based on the user input.

19. The smart mirror of claim 1, wherein the smart mirror is supported within a cabinet configured for coupling to a wall.

20. A system comprising:
a property management system; and
a smart mirror communicatively coupled to the property management system, the smart mirror including:
a controller configured for communication with the property management system;
a semi-transparent mirror panel; and
a display configured to render a user interface for projection through the semi-transparent mirror panel, the user interface adapted to:
present information from the property management system, and
receive a user input from an input device for communication with the property management system.
